(19) United States
(12) Patent Application Publication
(10) Pub. No.: US 2005/0196104 A1
(43) Pub. Date: Sep. 8, 2005

(54) Connector having arrangement of fixing optical fibers without using adhesive

(76) Inventor: Chin Ju Liu, Taipei (TW)

Correspondence Address: TROXELL LAW OFFICE PLLC, Suite 1404, 5205 Leesburg Pike, Falls Church, VA, 22041, US

(21) Appl. No.: 10/790,078

(22) Filed: Mar. 2, 2004

(51) Int. Cl. G02B 6/36

(52) U.S. Cl. 385/78

(57) ABSTRACT

A connector of a bundle of optical fibers comprises a ferrule including an axial lower channel for receiving the bundle of optical fibers, and an axial upper tunnel in communication with the channel, and a rigid, cylindrical sheath received in the tunnel and including a bore for receiving the bundle, an aperture through a closed end of the sheath, and an annular neck. Inserting the bundle into the channel and the tunnel until being stopped with strands of optical fiber passed the aperture, and then pressing the sheath will break the sheath at the neck and compress the neck inwardly into the sheath to form a narrow section around the bundle for fastening. An additional base is provided in another embodiment.

### BACKGROUND OF THE INVENTION

1. Field of the Invention

The present invention relates to connectors and more particularly to an improved connector having an arrangement of fixing one or more strands of optical fiber without using adhesive.

2. Description of Related Art

Fiber optics as means of transmitting light and images has been widely employed due to its features of small diameter, wide bandwidth, low transmission loss, etc. A fiber optical communication system comprises a trunk including a plurality of branches each extended to an end user. Typically, a plurality of connectors of optical fibers, interconnected the branch and the end user, are provided for increasing the transmission distance.

A conventional connector 2 of a bundle 1 of optical fibers including one or more strands of optical fiber (one strand of optical fiber as shown) is shown in FIGS. 1A and 1B. The connector 2 comprises an elongated ferrule 3 and a cylindrical base 4 coupled to one end of the ferrule 3. A channel 5 is longitudinally formed along the axis of the ferrule 3 for receiving the strand of optical fiber 9. The channel 5 is in communication with a longitudinal tunnel 6 of the base 4. The strand of optical fiber 9 is surrounded by a layer of insulating medium 7. Also, the layer of insulating medium 7 is surrounded by a cylindrical conductor 8 which is, in turn, received in the tunnel 6. In assembly, insert a portion of the ferrule 3 into an upper socket of the base 4 with an extended portion of the strand of optical fiber 9 being inserted into the channel 5 by passing a conic portion 10 at one end of the channel 5. Further, adhesive 10 is filled into the conic portion 10. The adhesive 10 will be cured after a predetermined period of time for fixing the strand of optical fiber 9 and the connector 2.

But this is unsatisfactory for the purpose for which the invention is concerned for the following reasons: Bubbles 12 may form in the adhesive 10. Also, bubbles 12 may move slightly due to expansion or contraction caused by temperature change. Such can bend the strand of optical fiber 9 and thus adversely affect the transmission quality. Thus, the need for improvement still exists.

### SUMMARY OF THE INVENTION

It is an object of the present invention to provide a connector of a bundle of optical fibers surrounded by an insulating medium which is surrounded by a cylindrical conductor, a plurality of strands of optical fiber at one end of the bundle of optical fibers being exposed, comprising a ferrule comprising an axial lower channel for receiving the bundle of optical fibers, and an axial upper tunnel in communication with the channel, and a rigid, cylindrical sheath received in the tunnel and comprising a bore having a diameter about the same as that of the channel for receiving the bundle of optical fibers, an aperture through a closed end of the sheath, and an annular neck, whereby inserting the bundle of optical fibers into the channel and the tunnel until being stopped with the strands of optical fiber passed the aperture, and pressing the sheath will break the sheath at the neck and compress the neck inwardly into the sheath to form a narrow section around the bundle of optical fibers for fastening the strands of optical fiber which, in turn, are forced to insert through the aperture. By utilizing the present invention, it is possible of fixing a bundle of optical fibers at a connector without using adhesive.

In one aspect of the present invention further comprises a cylindrical base including a second channel having a diameter about the same as that of the channel and being in communication therewith so as to receive the bundle of optical fibers, and an upper socket for fastening a lower portion of the ferrule therein. The above and other objects, features and advantages of the present invention will become apparent from the following detailed description taken with the accompanying drawings.

### BRIEF DESCRIPTION OF THE DRAWINGS

FIG. 1A is a cross-sectional view of a conventional connector of optical fibers;

FIG. 1B is a detailed view of the area in circle 1B in FIG. 1A;

FIGS. 2A and 2B are different cross-sectional views of a first preferred embodiment of connector of optical fibers according to the invention;

FIG. 3 is a cross-sectional view showing the compressed sheath after exerting force along the direction X shown in FIG. 2B;

FIG. 4 is a cross-sectional view similar to FIG. 3 with the strand of optical fiber being passed and fixed;

FIGS. 5A and 5B are different cross-sectional views of a second preferred embodiment of connector of optical fibers according to the invention;

FIG. 6 is a cross-sectional view showing the compressed sheath after exerting force along the direction X shown in FIG. 5B; and

FIG. 7 is a cross-sectional view similar to FIG. 6 with the strand of optical fiber being passed and fixed.

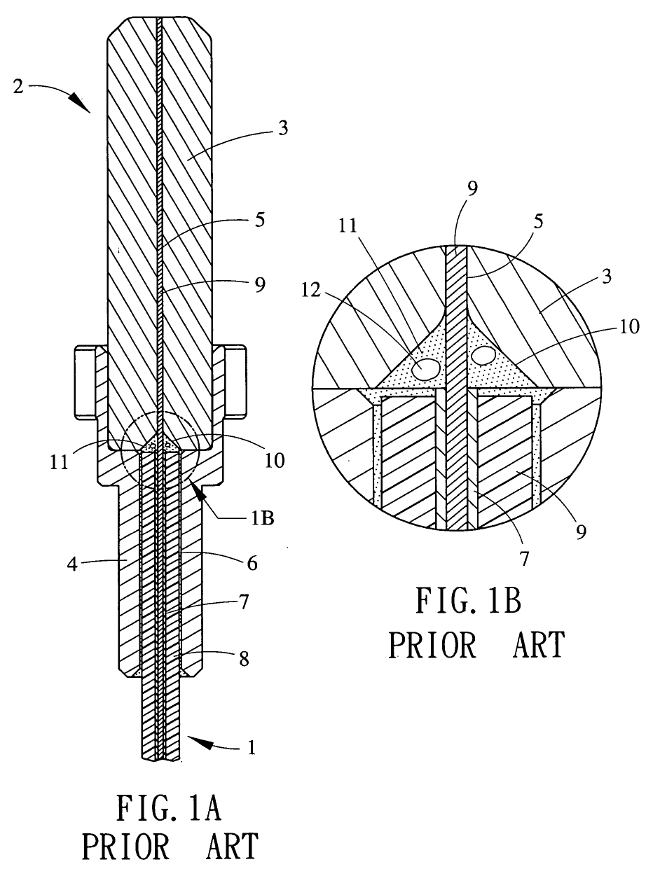

### DETAILED DESCRIPTION OF THE PREFERRED EMBODIMENTS

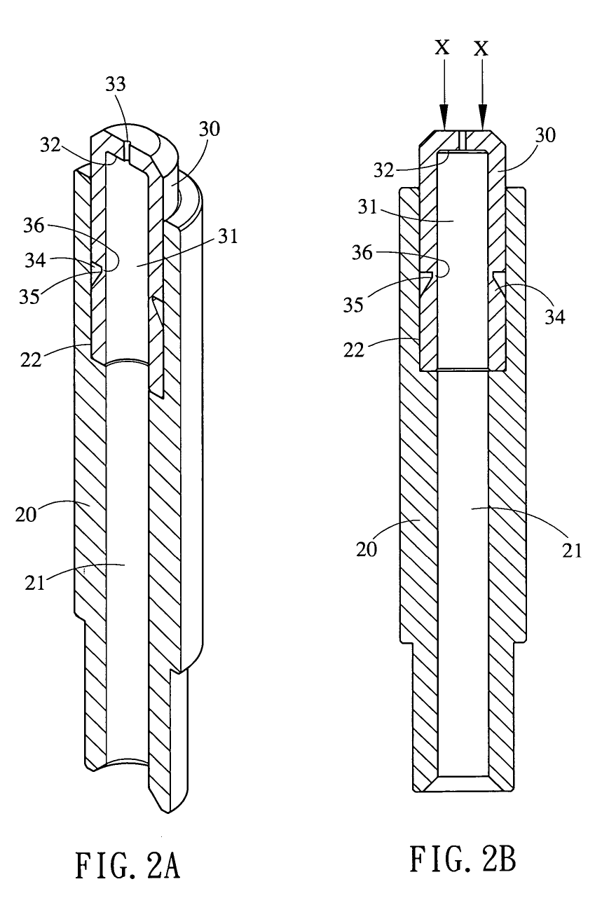

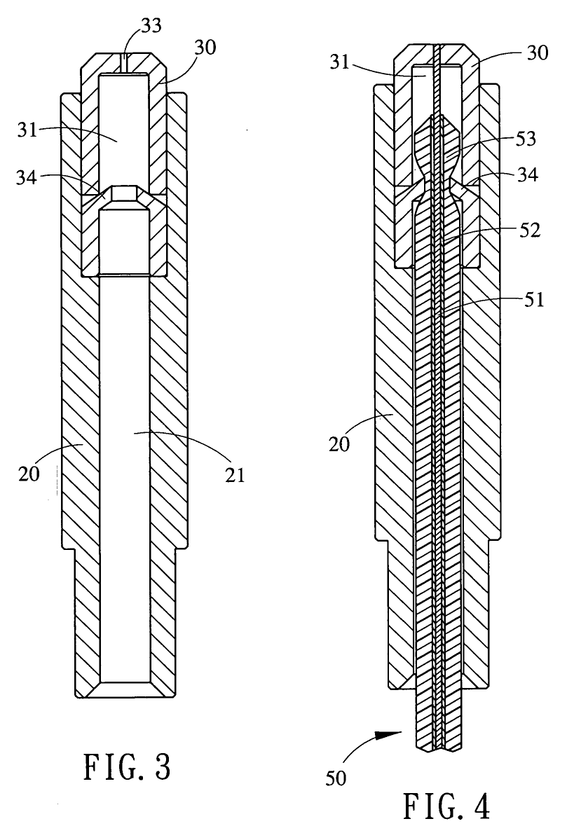

Referring to FIGS. 2A, 2B, 3, and 4 there is shown a first preferred embodiment of connector of optical fibers of the invention. The connector comprises a ferrule 20 and a rigid, cylindrical sheath 30. The connector is coupled to a bundle 50 of optical fibers including one or more strands of optical fiber (one strand of optical fiber 51 as shown). The bundle of optical fibers 50 is surrounded by an insulating medium 52 which, in turn, is surrounded by a solid outside conductor 53 in the form of a cylindrical shell. End portions of the insulating medium 52 and the conductor 53 are ripped to expose a predetermined length of the strand of optical fiber 51.

The ferrule 20 comprises an axial lower channel 21 for receiving the strand of optical fiber 51, the insulating medium 52, and the conductor 53, and an axial upper tunnel 22 in communication with the channel 21, the tunnel 22 adapted to tightly receive the sheath 30. The sheath 30 comprises a bore 31 having a diameter about the same as that of the channel 21 for receiving the strand of optical fiber 51, an internal surface 32 at a bottom of the bore 31, an aperture 33 through the surface 32, the aperture 33 adapted to pass the strand of optical fiber 51 as detailed later, and an annular neck 34 around an intermediate portion, the neck 34 having an inclined portion 35 to form a narrow portion 36.

An assembly of the first preferred embodiment will now be described in detail below. First, insert the strand of optical fiber 51, the insulating medium 52, and the conductor 53 into the channel 21 and the tunnel 22 until being stopped by the surface 32 with the strand of optical fiber 51 passed the aperture 33. Next, press the sheath 30 (as indicated by arrows Xs) to break the sheath 30 at the narrow portion 36 and thus compress the neck 34 inwardly. As a result, the insulating medium 52 and the conductor 53 are deformed to form a narrow section to fasten the strand of optical fiber 51 which, in turn, is forced to insert through the aperture 33 (see FIG. 4).

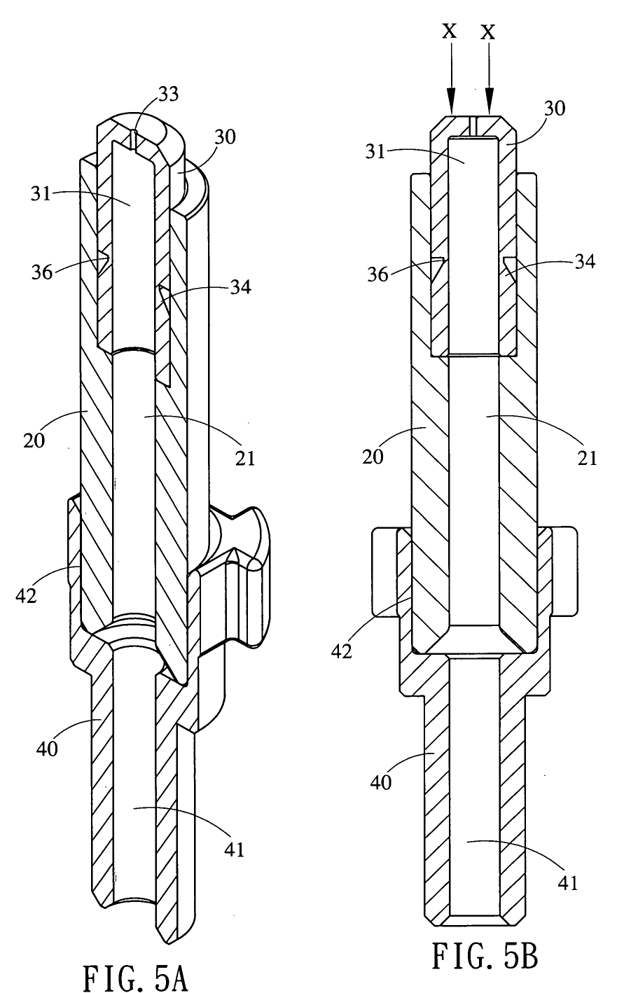

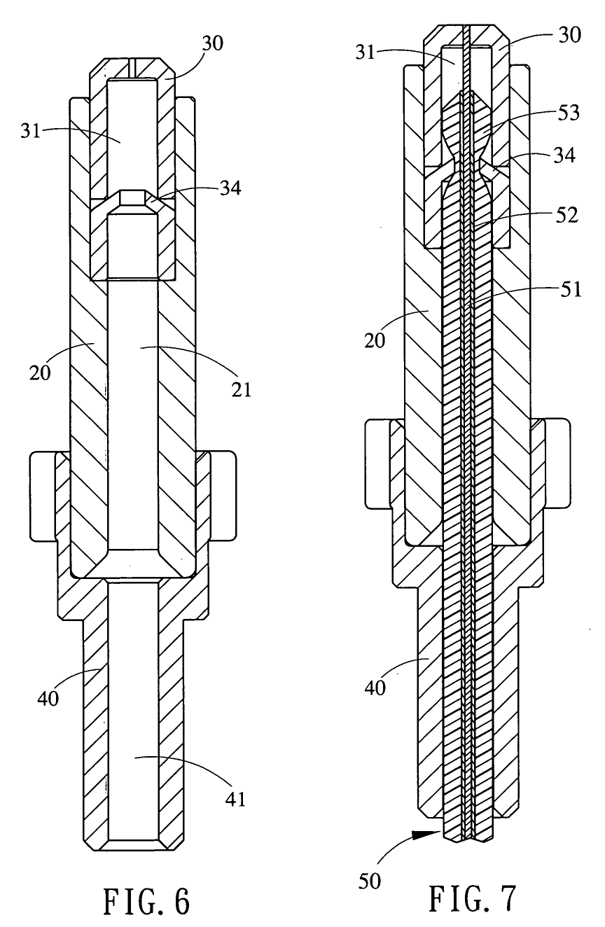

Referring to FIGS. 5A, 5B, 6, and 7 there is shown a second preferred embodiment of connector of optical fibers of the invention. The second preferred embodiment substantially has same structure as the first preferred embodiment. The differences between the first and the second preferred embodiments, i.e., the characteristics of the second preferred embodiment are detailed below. The second preferred embodiment comprises a cylindrical base 40 including a channel 41 having a diameter about the same as that of the channel 21 for receiving the strand of optical fiber 51, and an upper socket 42 for fastening a lower portion of the ferrule 20 therein. An assembly of the second preferred embodiment will now be described in detail below. First, insert the strand of optical fiber 51, the insulating medium 52, and the conductor 53 into the channels 41 and 21 and the tunnel 22 until being stopped by the surface 32 with the strand of optical fiber 51 passed the aperture 33. Next, press the sheath 30 (as indicated by arrows Xs) to break the sheath 30 at the narrow portion 36 and thus compress the neck 34 inwardly. As a result, the insulating medium 52 and the conductor 53 are deformed to form a narrow section to fasten the strand of optical fiber 51 which, in turn, is forced to insert through the aperture 33 (see FIG. 7).

While the invention herein disclosed has been described by means of specific embodiments, numerous modifications and variations could be made thereto by those skilled in the art without departing from the scope and spirit of the invention set forth in the claims.

1. A connector of a bundle of optical fibers surrounded by an insulating medium which is surrounded by a cylindrical conductor, a plurality of strands of optical fiber at one end of the bundle of optical fibers being exposed, comprising:
a ferrule comprising an axial lower channel for receiving the bundle of optical fibers, and an axial upper tunnel in communication with the channel; and
a rigid, cylindrical sheath received in the tunnel and comprising a bore having a diameter about the same as that of the channel for receiving the bundle of optical fibers, an aperture through a closed end of the sheath, and an annular neck,
whereby inserting the bundle of optical fibers into the channel and the tunnel until being stopped with the strands of optical fiber passed the aperture, and pressing the sheath will break the sheath at the neck and compress the neck inwardly into the sheath to form a narrow section around the bundle of optical fibers for fastening the strands of optical fiber which, in turn, are forced to insert through the aperture.

2. The connector of claim 1, wherein the neck comprises an inclined surface to form a narrow portion which is susceptible of break.

3. The connector of claim 1, further comprising a cylindrical base including a second channel having a diameter about the same as that of the channel and being in communication therewith so as to receive the bundle of optical fibers, and an upper socket for fastening a lower portion of the ferrule therein.
